(19) United States
(12) Patent Application Publication
(10) Pub. No.: US 2002/0113838 A1
(43) Pub. Date: Aug. 22, 2002

(54) Printing method and printing apparatus for printing on a continuous sheet

(76) Inventors: Kenichi Nakajima, Nagano-ken (JP); Kunihiko Matsuhashi, Matsumoto-shi (JP)

Correspondence Address: HOGAN & HARTSON L.L.P., 500 S. GRAND AVENUE, SUITE 1900, LOS ANGELES, CA, 90071-2611, US

(21) Appl. No.: 10/058,976

(22) Filed: Jan. 28, 2002

(30) Foreign Application Priority Data
Feb. 5, 2001 (JP) 2001-028633

(51) Int. Cl. B41J 23/00

(52) U.S. Cl. 347/37

(57) ABSTRACT

There is provided provide a printing method and printing apparatus which is capable of printing on a continuous sheet at an increased printing speed without degrading print quality. A sheet feeding mechanism feed a continuous sheet. A head unit carries ink jet heads thereon. An X-Y moving mechanism moves the head unit in a main scanning direction and a sub scanning direction. The head unit is caused to perform main scanning and sub scanning on a printable area of the continuous sheet held stationary to thereby print images thereon, and after completion of the printing, the continuous sheet is fed in a direction in which it extends, to perform printing on the following printable area. These operations are repeatedly carried out to continuously print images on the continuous sheet.

### BACKGROUND OF THE INVENTION

1. Field of the Invention

This invention relates to a printing method and a printing apparatus for printing on a continuous sheet by moving an ink jet head in a main scanning direction and a sub scanning direction.

2. Prior Art

Conventionally, a serial printer (printing apparatus) based on an ink jet method performs printing of an image by reciprocatingly moving an ink jet head thereof in a main scanning direction and indexing a printing sheet in a sub scanning direction, to thereby printing an image on the printing sheet. In this case, the reciprocating motion of the ink jet head is performed by using a timing belt, and the feeding of the printing sheet is performed by using grip rollers.

In such a conventional printing apparatus, when the grip rollers sandwich the sheet for feeding the printing sheet, they are slightly depressed by the sandwiching force, to change the radius of each roller. Therefore, the grip rollers have a problem of liability to delicate variation in the feeding speed due to a change in the radius of each controller. Further, when printing is performed on a continuous sheet (printing tape) having a narrow width, the ink jet head prints over a short traveling distance for actual printing effected by ejection of ink droplets, compared with a traveling distance for acceleration and deceleration of the print head, which reduces a ratio of a traveling time for the actual printing to a traveling time for the acceleration and deceleration, resulting in a lowered printing speed as a whole.

### SUMMARY OF THE INVENTION

It is an object of the invention to provide a printing method and printing apparatus which is capable of printing on a continuous sheet at an increased printing speed without degrading print quality.

To attain the above object, according to a first aspect of the invention, there is provided a printing method for printing on a continuous sheet by moving an ink jet head in a main scanning direction and a sub scanning direction, the printing method comprising the steps of:

performing, on a printable area of the continuous sheet stopped in a sheet feeding path, main scanning in a direction in which the continuous sheet extends and sub scanning in a direction of width of the continuous sheet, to thereby print an image on the printable area; and

feeding the continuous sheet, after completion of the printing, in the direction in which the continuous sheet extends, to print on a following printable area of the continuous sheet,

the above steps being repeatedly carried out to perform continuous printing of the image.

Similarly, according to a second aspect of the invention, there is provided a printing apparatus for printing on a continuous sheet, comprising:

a sheet feed mechanism for feeding a continuous sheet along a sheet feeding path in a direction in which the continuous sheet extends;

a head unit carrying ink jet heads thereon for continuously printing an image on the continuous sheet;

an X-Y moving mechanism carrying the head unit thereon and for moving the head unit above the continuous sheet in a main scanning direction which is the direction in which the continuous sheet extends and a sub scanning direction which is a direction of width of the continuous sheet; and

a printing table facing toward the sheet feeding path and opposed to the ink jet heads in printing operation, with the continuous sheet positioned therebetween;

control means for controlling the sheet feed mechanism, the ink jet heads, and the X-Y moving mechanism, and

wherein the control means causes the ink jet heads to perform the main scanning and the sub scanning on a printable area of the continuous sheet which is stopped on the printing table, and feed the continuous sheet, after completion of the printing, in the direction in which the continuous sheet extends, to print on a following printable area of the continuous sheet, such that these operations are repeatedly carried out to perform continuous printing of the image.

According to the printing method and printing apparatus, the feeding of the continuous sheet is stopped and main scanning and sub scanning of an ink jet head (or ink jet heads) is performed on a printable area of the continuous sheet to print an image thereon, and then, the feeding of the continuous sheet is resumed to introduce a new printable area thereof, for printing of the image thereon. These operations are repeatedly carried out to perform continuous printing of the image on the continuous sheet. Thus, for printing operation of the ink jet head, the continuous sheet is stopped and held in an immovable state, whereby the printing can be performed with positioning accuracy on a dot level measurement of location. Further, in the printable area, particularly when the image is printed over a long distance in the main scanning direction (in the direction in which the continuous sheet extends), the reciprocating ink jet head moves over a sufficiently long traveling distance for actual printing (ejection of ink droplets) compared with a traveling distance for acceleration and deceleration of the print head, which increases a ratio of a traveling time for the actual printing to a traveling time for the acceleration and deceleration, thereby making it possible to perform printing at an increased printing speed as a whole.

Preferably, the printable area is set to have a sufficiently large length in the main scanning direction compared with a length in the sub scanning direction.

According to this preferred embodiment of each aspect of the invention, as the length of the printable area in the main scanning direction becomes longer than that of the same in the sub scanning direction, the ratio of a traveling time for the actual printing to a traveling time for the acceleration and deceleration becomes smaller, thereby making it possible to increase the printing speed as a whole.

Preferably, a plurality of unit images are printed in the printable area with non-print areas interposed in the main scanning direction.

Similarly, the control means causes a plurality of unit images to be printed in the printable area with non-print areas interposed in the main scanning direction.

According to these preferred embodiments, by using the unit image as an image on the label, for instance, it is possible to print a large number of labels efficiently and at an increased speed. Further, a required number of labels can be printed with ease and as desired.

More preferably, in the printing method, boundaries between the printable areas are included in the non-print areas.

Similarly, the control means causes feeding of the continuous sheet and printing thereon such that boundaries between the printable areas are included in the non-print areas.

According to the preferred embodiments, it is possible to perform printing such that no image exists in boundaries between printable areas (printed areas, in this case), which prevents printing from being carried out wastefully.

Preferably, in the printing method, the continuous sheet is rolled out from a state wound into a roll, and printed part of the continuous sheet is taken up into a roll.

Similarly, the printing apparatus further comprises a sheet feed mechanism for rolling out the continuous sheet from a state wound into a roll, and a sheet take-up mechanism for taking up printed part of the continuous sheet into a roll.

According to these preferred embodiments, the continuous sheet can be appropriately supplied and at the same time part thereof printed with images can be stored in a collective and compact form as a stock.

Preferably, the printing table comprises a suction table for performing sucking by suction of air.

According to this preferred embodiment, the printable area of the continuous sheet introduced onto the printing table can be stably held in a flat state. This makes it possible to effect stable printing with excellent print quality.

Preferably, the sheet feeding mechanism feeds the continuous sheet against the suction of air by the printing table.

According to this preferred embodiment, the ON-OFF control for suction by air is unnecessary between the feeding of the continuous sheet and the stopping of the same, thereby making it possible to simplify the control operation, and at the same time, the continuous sheet can be fed in a stretched state between the sheet feeding mechanism and the printing table, thereby making it possible to increase the accuracy of the feeding of the continuous sheet.

The above and other objects, features, and advantages of the invention will become more apparent from the following detailed description taken in conjunction with the accompanying drawings.

### BRIEF DESCRIPTION OF THE DRAWINGS

FIG. 1 is a plan view of a printing apparatus according to an embodiment of the invention;

FIG. 2 is a cross-sectional view of the FIG. 1 printing apparatus;

FIG. 3 is a perspective view showing the appearance of the FIG. 1 printing apparatus;

FIGS. 4A to 4C are views useful in explaining traveling operations of a head unit;

FIG. 5 is a perspective view showing the appearance of the head unit;

FIG. 6 is a view schematically showing the construction of the head unit;

FIG. 7 is a cross-sectional view schematically showing the construction of a storage unit;

FIG. 8 is a plan view schematically showing the storage unit and the head unit;

FIG. 9 is a cross-sectional view schematically showing the construction of a cleaning unit;

FIG. 10 is a plan view schematically showing the cleaning unit and the head unit;

FIG. 11 is a block diagram showing the arrangement of a control system of the FIG. 1 printing apparatus; and

FIGS. 12A to 12D are explanatory views showing results of printing by variations of the printing method.

### DETAILED DESCRIPTION OF PREFERRED EMBODIMENT

The invention will now be described in detail with reference to drawings showing a printing apparatus to which is applied a printing method and printing apparatus for printing on a continuous sheet, according to a preferred embodiment of the invention. The printing apparatus is a large-sized color printer for business use, which is capable of continuously printing label images by the ink jet printing method. More specifically, the printing apparatus is capable of continuously printing a large number of unit images on a printing tape as a continuous sheet, which has a release paper laminated thereon, such that portions of the tape printed with the unit images can be cut out afterwards for use as labels, and makes it possible to carry out small-lot printing e.g. for producing labels to be affixed to wrapping films for wrapping perishable food.

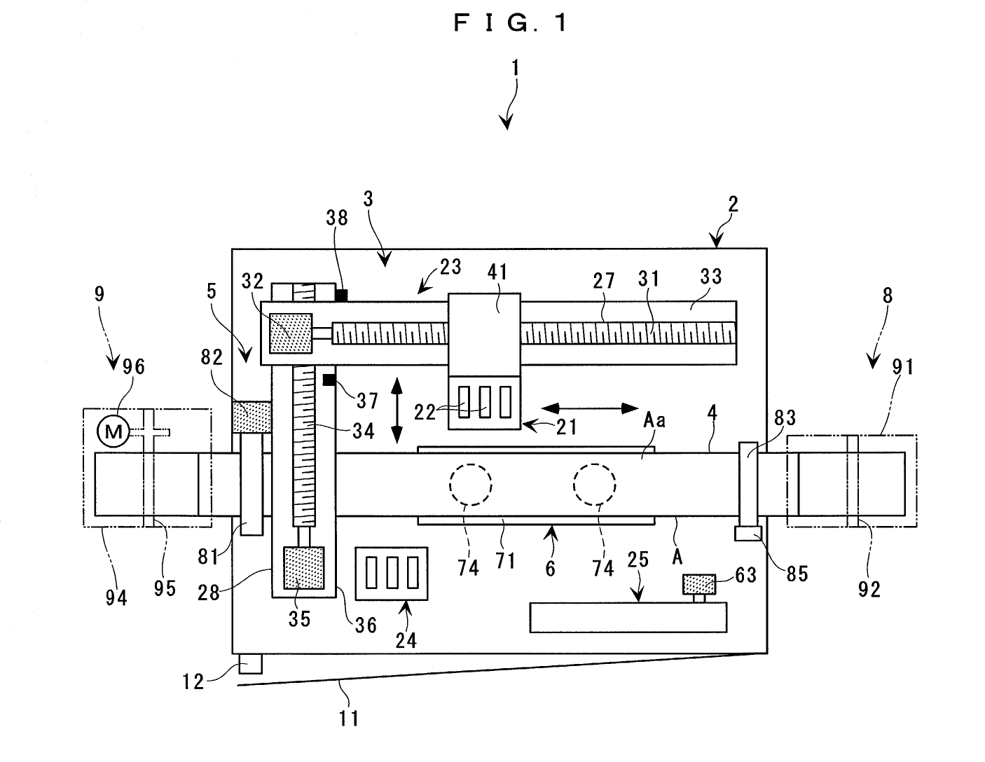

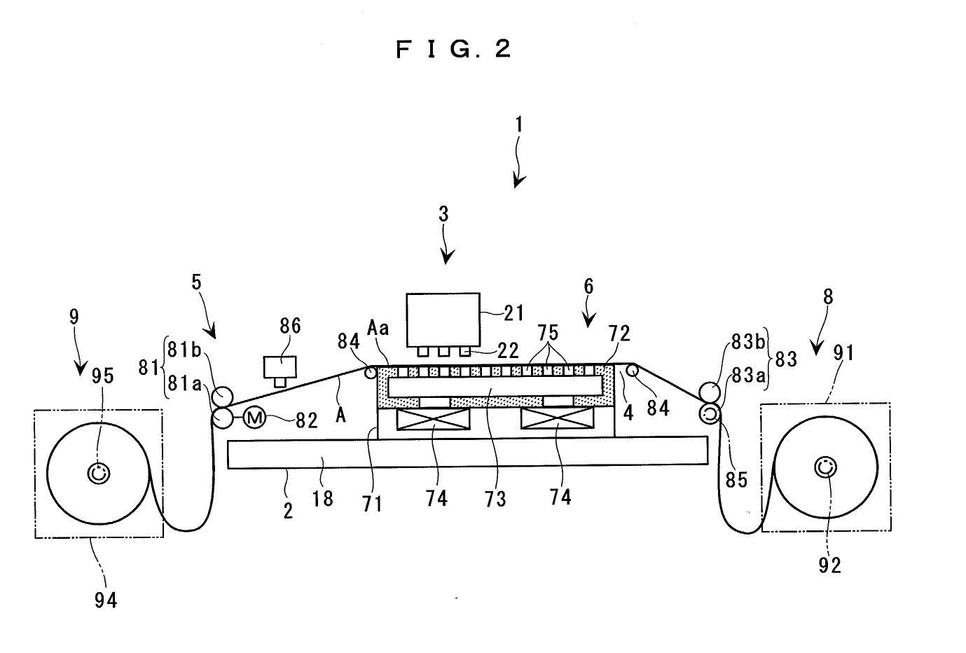

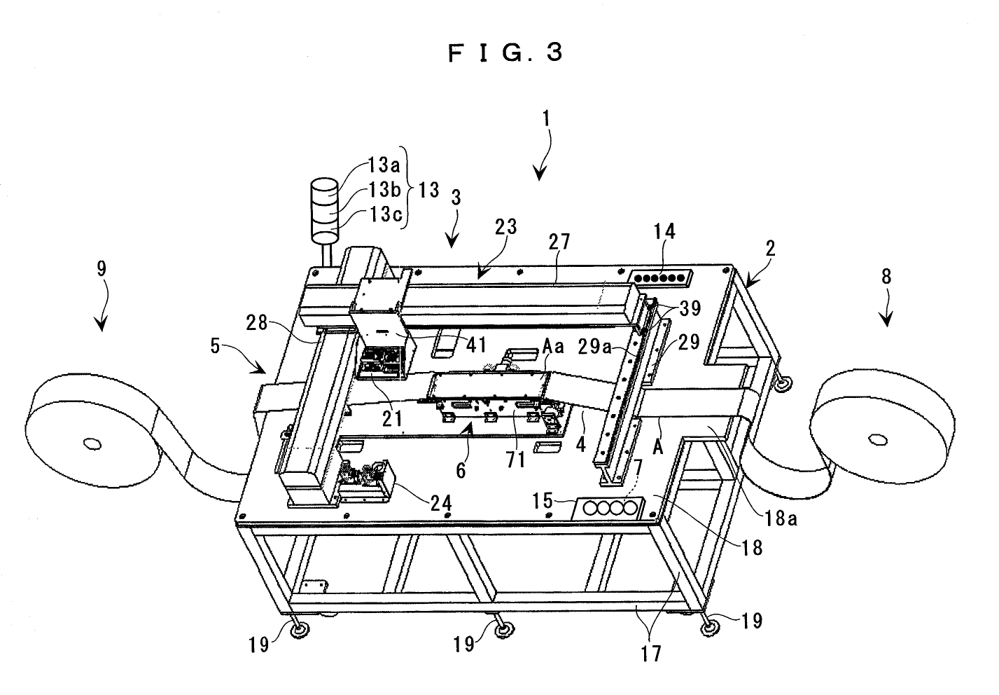

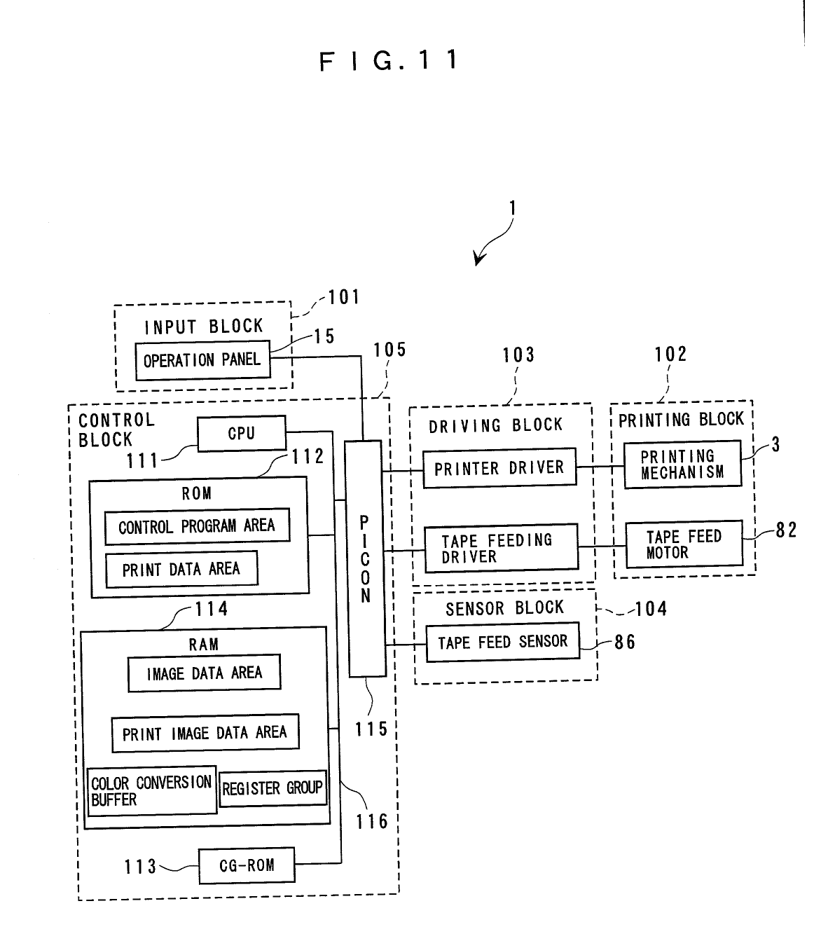

FIG. 1 schematically shows the printing apparatus in plan view, while FIG. 2 shows the same in cross section. Further, FIG. 3 shows the appearance of the whole printing apparatus. As shown in the figures, the printing apparatus 1 includes a base 2, a printing mechanism 3 arranged above the base 2, a tape feeding mechanism 5 for feeding a printing tape A along a tape feeding path (sheet feeding path) 4 extending longitudinally on the base 2, a suction table 6 arranged in a central portion of the tape feeding path 4, and a controller (control means: see FIG. 11) 7 for controlling the mechanisms 3 and 5. The printing apparatus 1 further includes a tape supply device 8 for rolling out a roll of the printing tape A and delivering the same to the tape feeding mechanism 5, and a tape take-up device 9 for taking up printed part of the printing tape A received from the tape feeding mechanism 5 into a roll.

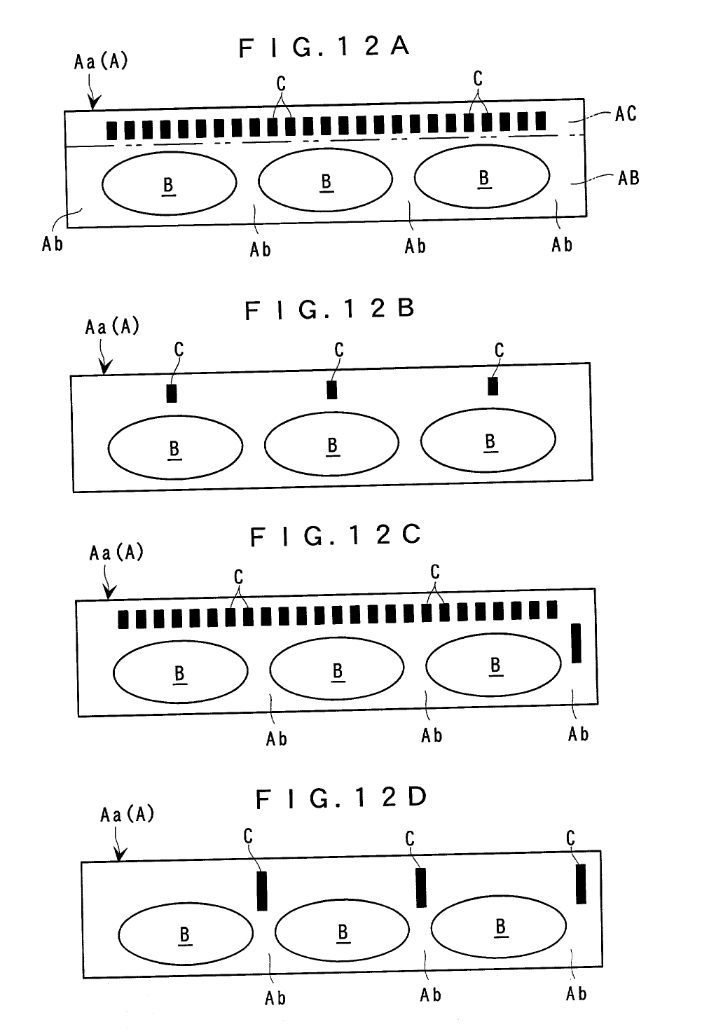

The printing tape A as a print medium is in the form of a roll of continuous paper with a so-called release paper laminated thereon. The printing tape A includes a plurality of kinds having respective tape widths ranging from 50 mm to 150 mm. In printing, images (unit images) B for respective labels are continuously printed on the printing tape A along the length of the same (see FIGS. 12A to 12D). The respective portions of the printing tape A each printed with the unit image B are half-cut by a cutter device provided separately from the printing apparatus 1, whereby labels with adhesive are produced.

Used for the printing, or color printing of lines, are inks of six basic colors, i.e. cyan (C), magenta (M), yellow (Y), black (K), light cyan (LC) and light magenta (LM). The inks of these six colors are supplied from ink tanks (stationary ink tanks) to respective ink jet heads 22 of an ink head unit 21 via associated ink tubes, as described in detail hereinafter.

On the base 2, there is provided a safety cover, not shown, collectively covering the above-mentioned mechanisms as a unit. The safety cover has a door 11 provided on a front face thereof (see FIG. 1). Further, a detection switch (detection sensor) 12 is attached to the safety cover, for detecting closing of the door 11. The main power is turned on only in a state of the closing of the door 11 having been detected by the detection switch 11. Further, when the door 11 is opened in an ON state of the main power, the main power is turned off via the detection switch 11.

In FIG. 3, reference numeral 13 designates an alarm lamp (which is actually erected on the safety cover) . The alarm lamp 13 includes an ink indicator lamp 13a for indicating ink end, a tape indicator lamp 13b for indicating tape end, and an operation indicator lamp 13c for indicating that the apparatus is in printing operation (in operation). Reference numeral 14 in the figure designates a group of ink lamps for each indicating the presence and absence of the inks of the six colors, described in detail hereinafter. Further, reference numeral 15 in the figure designates an operation panel. On the surface of the operation panel, there are arranged a power switch (main power), an emergency stop switch, a pause switch, a re-start switch, a tape feed switch (for idle or non-printing feeding), a head cleaning switch, and so forth. The operation panel 15 has a circuit board built therein which forms the aforementioned controller 7.

The base 2 is formed by assembling angle bars 17 into a base support having a rectangular parallelepiped shape and fixing a base plate 18 on the base support. The base 2 has six legs 19 attached to a bottom thereof such that each of the legs 19 can be adjusted in height. Further, the base 2 has an overhang 18a extending outward from one end thereof in a longitudinal direction, on which operation for extending the tape A by joining another thereto is carried out (see FIG. 3).

On the base plate 18, there are arranged main ink tanks (stationary tanks), not shown, for containing the inks of the respective colors, in a state secured on a small base, not shown. The inks can be delivered from the main ink tank to subsidiary ink tanks (stationary tanks) also arranged on the base plate 18. The inks of the respective colors are further delivered from the subsidiary ink tanks to the ink jet heads 22, described in detail hereinafter, via the respective associated ink tubes. The indicating operations of the ink indicator lamp 13a and the ink lamp group 14 are performed based on results of detection concerning the presence or absence of the respective inks in the main ink tanks.

The printing mechanism 3 includes a head unit 21 carrying a large number of ink jet heads 22, an X-Y moving mechanism 23 for moving the head unit 21, in main and sub scanning directions, as desired, a storage unit 24 for use in storing the ink jet heads 22 (when they are not in operation) and in flushing the same, and a cleaning unit 25 for use in cleaning the ink jet heads 22 (by manual operation).

The X-Y moving mechanism 23 is a so-called X-Y robot installed on the base 2. The X-Y moving mechanism 23 is comprised of an X-axis stage 27 for moving the head unit 21 in an X-axis direction (main scanning direction), a Y-axis stage 28 for moving the X-axis stage 27 in a Y-axis direction (sub scanning direction), and a Y-axis guide rail 29 for guiding the motion of the X-axis stage 27. The X-axis stage 27 is comprised of a main scanning ball screw 31 for reciprocating the head unit 21 in the main scanning direction (X-axis direction), a main scanning motor 32 for rotating the main scanning ball screw 31 in normal and reverse directions, and an X-axis casing 33 housing these components.

The Y-axis stage 28 is comprised of a sub scanning ball screw 34 for reciprocating the head unit 21 in the sub scanning direction (Y-axis direction), a sub scanning motor 35 for rotating the sub scanning ball screw 34 in normal and reverse directions, and a Y-axis casing 36 housing these components. The Y-axis guide rail 29 extends in parallel with the Y-axis stage 28, and cooperates with the Y-axis stage 28 to support the X-axis stage 27 at opposite ends thereof and guide the reciprocating motion of the X-axis stage 27.

In FIG. 1, reference numeral 37 designates an X-axis direction sensor for detecting a reference position (home position) of the head unit 21 in the X-axis direction, while reference numeral 38 designates a Y-axis direction sensor for detecting a reference position (home position) of the head unit 21 in the Y-axis direction. Whenever the main power of the printing apparatus 1 is turned on, the X-Y moving mechanism 23 is reset to the reference position.

The head unit 21 has a female screw block, not shown, attached thereto such that the female screw block extends into the X-axis casing 33 through a horizontal slit formed in the X-axis casing 33, and the female screw block is engaged with the main scanning ball screw 31. Similarly, attached to one end of the X-axis stage 27 is a female screw block, not shown, such that the female screw block extends into the Y-axis casing 36 through a horizontal slit formed in the Y-axis casing 36, and the female screw block is engaged with the sub scanning ball screw 34. Further, the X-axis stage 27 has a pair of guide rollers 39, 39 attached to the other end thereof such that the guide rollers 39, 39 can roll along a rail portion 29a of the Y-axis guide rail 29 (see FIG. 3).

The main scanning motor 32 and the sub scanning motor 35 are connected to the controller 7. When the controller 7 causes normal and reverse rotations of the main scanning motor 32, the head unit 21 performs reciprocating motion in the main scanning direction, whereas when the controller 7 causes normal and reverse rotations of the sub scanning motor 35, the head unit 21 performs reciprocating motion in the sub scanning direction. Printing of each line is effected by the motion of the head unit 21 in the main scanning direction, and a shift of the head unit 21 to a next line is effected by the motion of the head unit 21 in the sub scanning direction.

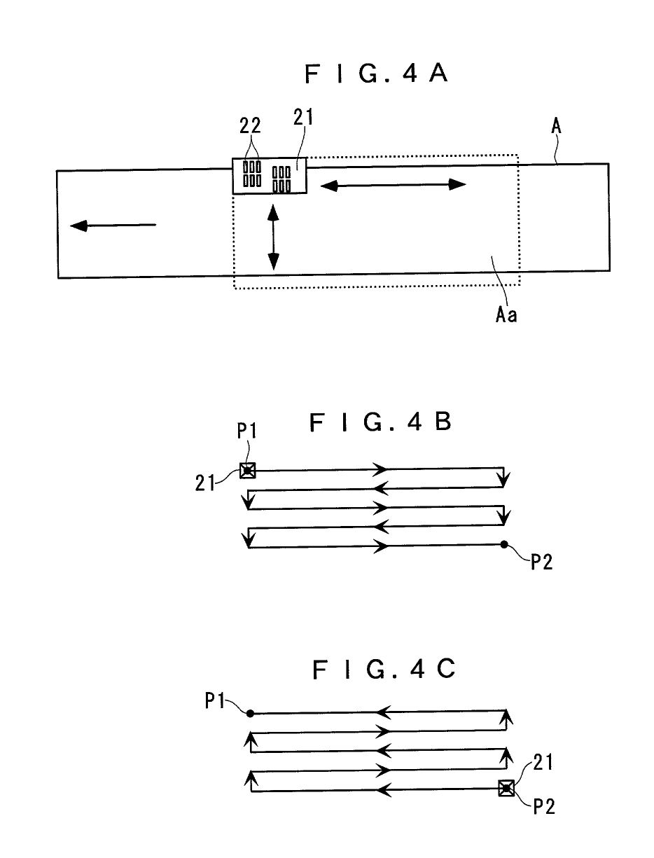

More specifically, referring to FIGS. 1 and 4A to 4C, when printing is started e.g. with an upper left-hand position on the tape as a printing-start position P1, the head unit 21 is moved rightward (in the main scanning direction) from the printing-start position P1, whereby printing (main scanning) of a first line is carried out, and then after being moved forward (downward as viewed in the figures) from an upper right-hand end for shift (sub scanning) to a second line, the head unit 21 is moved leftward (in the main scanning direction), whereby printing (main scanning) of the second line is carried out. Similar operations are repeatedly carried out for printing of all lines (see FIG. 4B). Further, e.g. when printing is completed at a lower right-hand position, the following printing after a tape feed is carried out from the printing-end position P2 toward the printing-start position P1 for printing of all the lines, following the above operating procedure in reverse (see FIG. 4C). Thus, time losses due to movement of the head unit 21 are reduced.

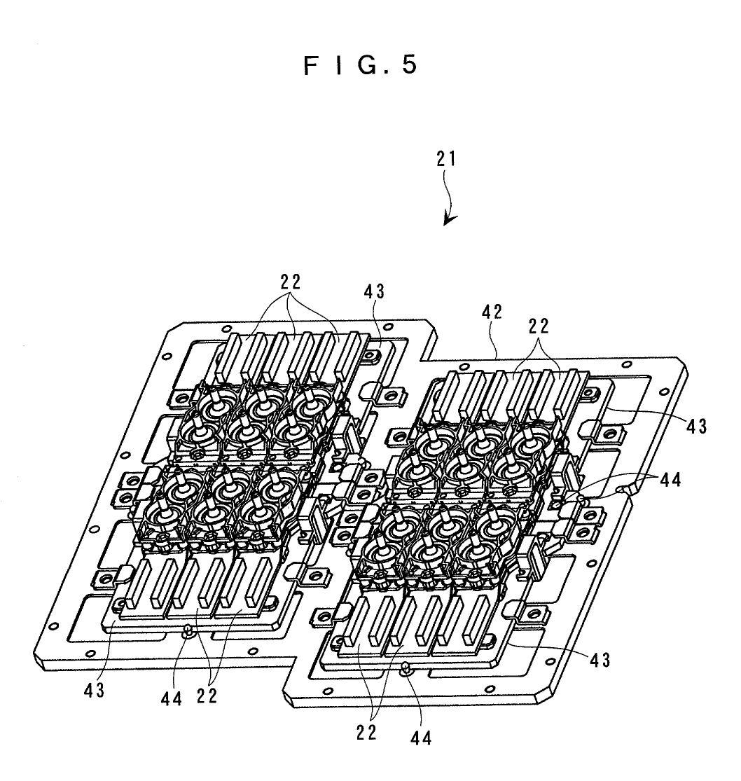

As shown in FIGS. 1, 3 and 5, the head unit 21 includes a support bracket 41 having the female screw block attached to a rear surface thereof, a unitary carriage 42 attached to a lower portion of the support bracket 41 such that the unitary carriage 42 extends horizontally, and four sub-carriages 43 removably mounted on the unitary carriage 42. Each of the sub-carriages 43 has three ink jet heads 22 mounted thereon in a row. In other words, twelve ink jet heads 22 in total are mounted on the four sub-carriages 43.

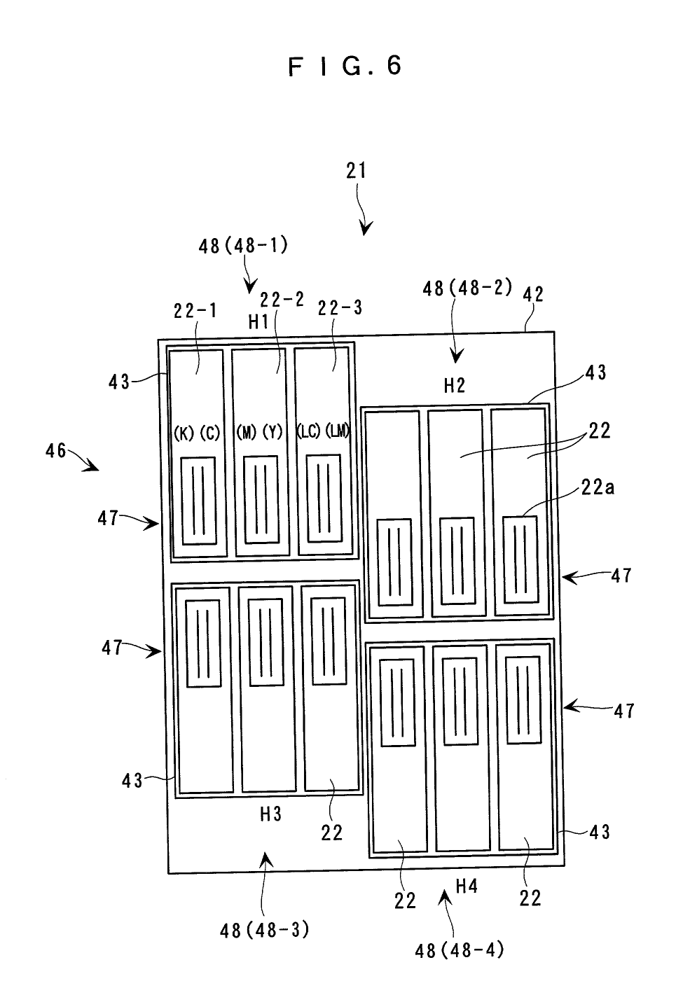

The ink jet heads 22 are each fixedly bonded to a corresponding one of the four sub-carriages 43, and the four sub-carriages 43 are removably mounted on the unitary carriage 42 by positioning/mounting means 44 comprised of a plurality of pins. Further, the ink jet heads 22 mounted on the sub-carriages 43 have respective main bodies 22a each formed with ink nozzles and projecting downward from the unitary carriage 42. The ink jet heads 22 on one sub-carriage 43 are arranged in a manner such that the main bodies 22a thereof are opposed to those of the ink jet heads 22 on another sub-carriage 43 adjacent to the one sub-carriage 43 in the Y-axis direction, whereby the ink nozzles are intensively disposed to form an ink nozzle array group 46 (see FIG. 6).

As schematically shown in FIG. 6, the ink nozzle array group 46 of ink nozzle arrays of the six colors employed as basic colors is divided into four, and ink nozzle arrays of the six colors of each divisional ink nozzle array group 47 are mounted on the sub-carriages 43 in a state incorporated in the three ink jet heads 22. More specifically, a first head 22-1 of the three ink jet heads 22 mounted on each of the sub-carriages 43 incorporates two divisional ink nozzle arrays 47a of black (K) and cyan (C) colors, a second head 22-2 incorporates two divisional ink nozzle arrays 47a of magenta (M) and yellow (Y) colors, and a third head 22-3 incorporates two divisional ink nozzle arrays 47a of light cyan (LC) and light magenta (LM) colors.

The divisional nozzle array groups 47 are arranged in a staggered and partially overlapping manner, to form, as a whole, the ink nozzle array group 46 for one line of dots of the colors which has a length of approximately four inches. The ink nozzle array group 46 for one line is divided into four, and the ink jet head 22 is formed by incorporating one of the four divisions of the ink nozzle array group 46. This makes it possible to replace a faulty ink jet head with a new one as required, and thereby improving the yield of the ink jet head unit.

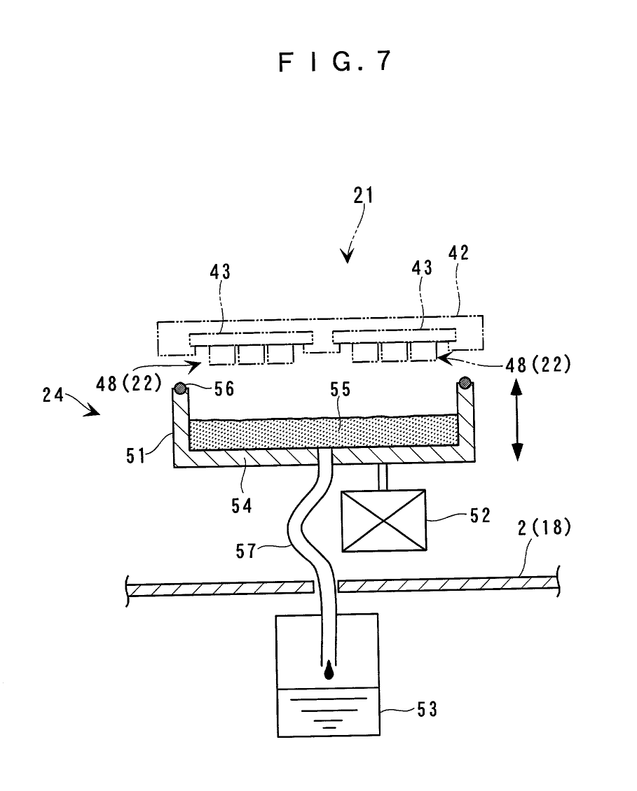

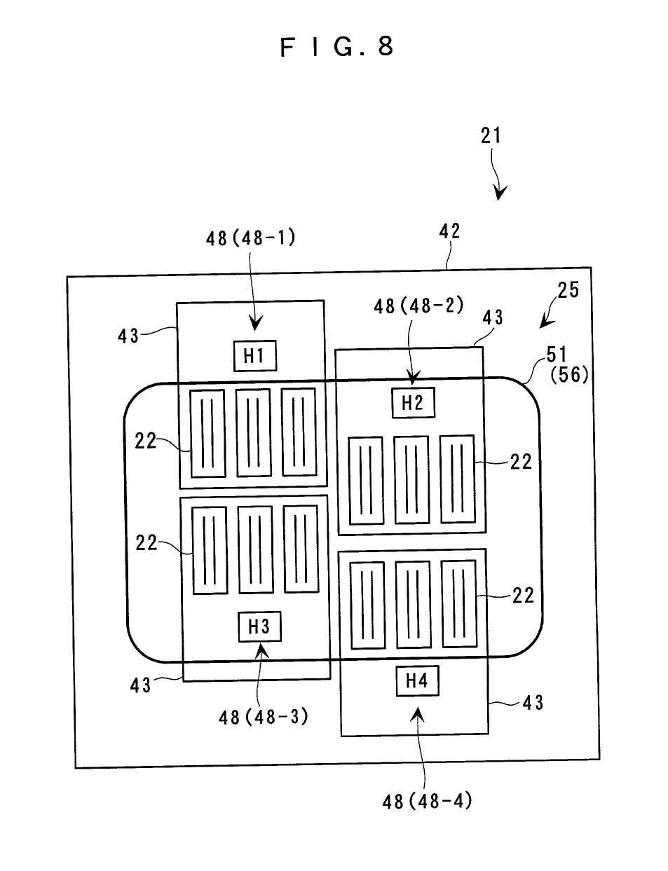

The storage unit 24 is arranged on the base 2 at a location close to a portion of the Y-axis stage 28 frontwardly, or downwardly as viewed in FIG. 1, off the tape feeding path 4. As shown in FIGS. 7 and 8, the storage unit 24 is comprised of a storage cap 51, a lift device 52 for moving the storage cap 51 up to and away from the head unit 21, a waste ink tank 54 for storing ink dropping from the storage cap 51. Needless to say, the lift device 52 is connected to the controller 7.

The storage cap 51 is comprised of a cap body 54, an ink absorbent material 55 filling a lower portion within the cap body 54, and a seal member 56 formed by a generally square O ring mounted to the upper periphery of the cap body 54. The seal member 56 is large enough to cover all the ink jet heads 22, and hence it can be brought into intimate contact with the underside surface of the unitary carriage 42, for sealing all the ink jet heads 22.

When the head unit 21 is brought to a position immediately above the storage cap 51 for flushing, the lift device 52 holds the storage cap 51 in its lowered position, whereas when the head unit 21 is brought to the position immediately above the storage cap 51 for storage, the lift device 52 lifts the storage cap 51 to bring the same into intimate contact with the head unit 21. Ink discharged by flushing is absorbed in the ink absorbent material 55, and when the ink absorbent material 55 becomes saturated with the ink, the ink drops through a tube 57 into the waste ink tank 53 arranged below the base plate 18. On the other hand, when the storage cap 51 is held in intimate contact with the head unit 21 for storage, the inside of the storage cap 51 is held in a very humid state by the ink absorbed in the ink absorbent material 55, which effectively prevents the ink jet heads (ink nozzles) 22 from being dried.

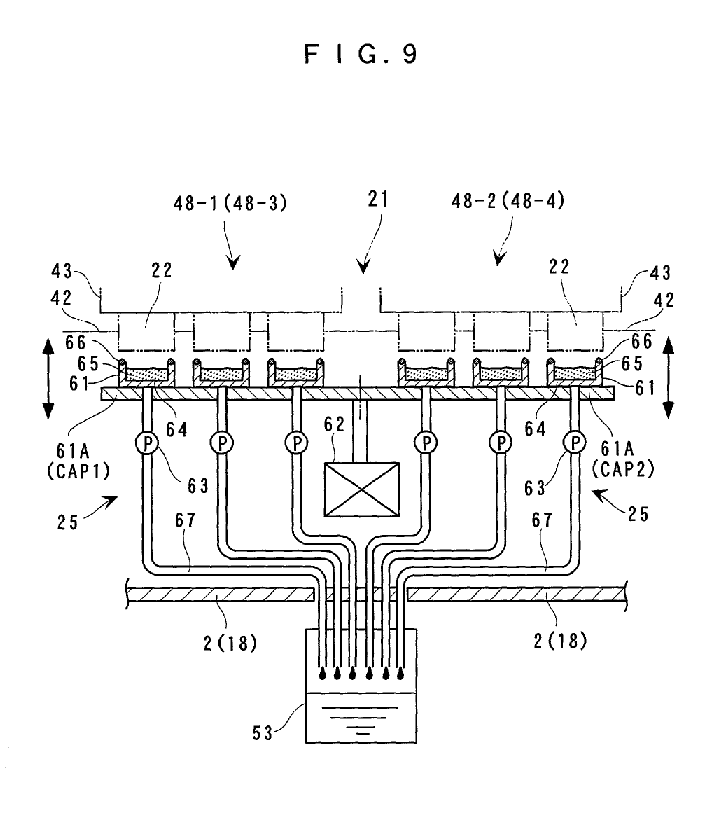

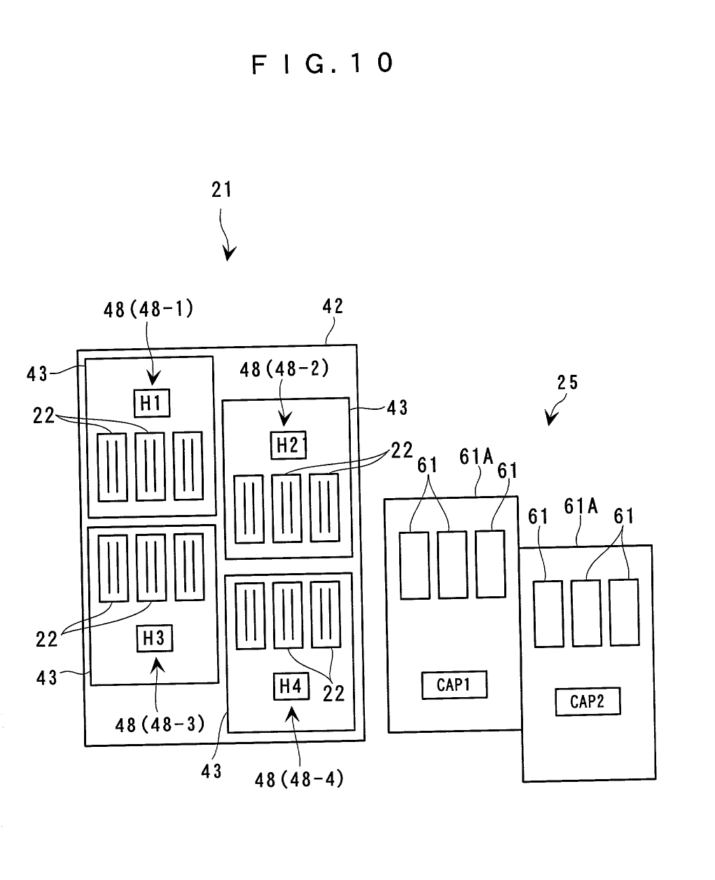

The cleaning unit 25 is arranged on the base 2 at a location frontwardly off the tape feeding path 4. As shown in FIGS. 9 and 10, the cleaning unit 25 is comprised of a pair of cap bases 61A, 61A each having three cleaning caps 61 mounted thereon, a lift device 62 for lifting and lowering the pair of cap bases 61A, 61A to thereby move the six cleaning caps 61 up to and away from the head unit 21, and six ink pumps 63 for sucking ink via the respective cleaning caps 61. The lift device 62 and the ink pumps 63 are each connected to the controller 7.

Each of the cleaning caps 61 is comprised of a cap body 64, an ink absorbent material 65 filling the lower portion within the cap body 64, and a seal member 66 mounted on the upper end or brim of the cap body 64. The pair of cap bases 61A, 61A are coupled to each other, and each of the cap bases 61A, 61A has the three cleaning caps 61 mounted thereon in a row in a manner corresponding to the three ink jet heads (head group 48) 22 mounted on the sub-carriage 43.

More specifically, one (CAP 1 in the figures) of the cap bases 61A, 61A corresponds to a first head group 48-1 (and a third head group 48-3), while the other cap base (CAP 2 in the figures) 61A corresponds to a second head group 48-2 (and a fourth head group 48-4). Further, the pair of cap bases 61A, 61A are arranged in a manner displaced from each other in the Y-axis direction such that they can correspond to two adjacent head groups (the first and second head groups; and the third and fourth head groups) 48. The lift device 62 lifts and lowers the pair of cap bases 61A, 61A in unison.

When the first head group 48-1 and the second head group 48-2 are brought to a position above the pair of cap bases 61A, 61A of the cleaning unit 21 for cleaning, the lift device 62 operates to lift the cap bases 61A, 61A for intimate contact between all the cleaning caps 61 and the head unit 21. Subsequently, the ink pumps 63 operate to suck ink (for cleaning) from the respective ink jet heads 22 of the first head group 48-1 and the second head group 48-2.

Then, the lift device 62 operates again to lower all the cleaning caps 61, and at the same time, the X-Y moving mechanism 23 operates to move the third head group 48-3 and the fourth head group 48-4 in the Y-axis direction and bring the head groups to the pair of cap bases 61A, 61A. Subsequently, lifting of the cleaning caps 61 and pumping operation are carried out for suction of ink (for cleaning) from the respective ink jet heads 22 of the third head group 48-3 and the fourth head group 48-4.

The inks sucked by the respective ink pumps 63 are each guided to the waste ink tank 53 through a corresponding one of the ink tubes 67. Since the head unit 21 can be moved, as required, by the X-Y moving mechanism 23 as described above, it is possible to reduce the number of caps, thereby making the cleaning unit 25 compact in size. It should be noted that if it is required to further reduce the number of caps, one (CAP 2 in the figures) of the cap bases 61A can be omitted. In this case, four pumping operations are needed to complete cleaning. Further, it is possible even to form a cleaning unit 25 having a single cap, though a further increased number of pumping operations are needed.

As shown in FIGS. 2 and 3, the suction table 6 is comprised of a casing 71 fixedly arranged on the base 2, a suction plate 72 mounted on the upper surface of the casing 71, a suction chamber 73 formed under the suction plate 72, and a pair of suction fans 74, 74 arranged in a manner continuous with the suction chamber 73. The suction plate 72 longitudinally extending along the tape feeding path 4 has an upper surface thereof formed with numerous suction holes 75 each communicating with the suction chamber 73. Further, the suction plate 72 is arranged in a horizontal position such that it can be opposed to the ink jet heads 22 moving immediately thereover in the X-Y direction in parallel therewith. More specifically, the printing tape A sucked onto the upper surface of the suction plate 72 is opposed to the ink jet heads 22 in parallel therewith with a predetermined space maintained therefrom for receiving ink droplets ejected from the ink jet heads 22.

The pair of suction fans 74, 74 are connected to the controller 7 and operated in synchronism with turning-on of the main power. More specifically, the suction table 6 keeps sucking the printing tape A not only during stoppage of the printing tape A but also during feeding of the same, and particularly, the printing tape A is fed against the sucking force of the suction table 6 during a feeding operation. The width of an area in which a large number of suction holes 75 are arranged is set to the width (50 mm) of a printing tape A having the smallest width so as to prevent leakage of suction air. It should be noted that air discharged from the pair of suction fans 74, 74 may be guided to the tape feeding path 4 downstream of the suction table 6 to speed up drying of ink on the tape A.

As shown in FIGS. 1 to 3, the tape feeding mechanism 5 includes tape feed roller means 81 arranged at a location downstream of the suction table 6 in the feeding direction, a tape feed motor 82 for driving the tape feed roller means 81 for rotation, tension roller means 83 arranged at a location upstream of the suction table 6 in the feeding direction, and a pair of guide rollers 84, 84 (see FIG. 2) arranged at respective locations upstream and downstream of the suction table 6 and close to the same. The tape feed roller means 81 is comprised of a drive roller 81a and a free roller 81b opposed to each other with the printing tape A therebetween. The tape feed motor 82 is connected to the drive roller 81a.

Similarly, the tension roller means 83 is comprised of a brake roller 83a and a free roller 83b opposed to each other with the printing tape A therebetween. The brake roller 83a has a torque limiter 85 fitted on a shaft thereof. Further, the pair of guide rollers 84, 84 position the printing tape A in the direction of width at the respective locations upstream and downstream of the suction table 6, and at the same time bring the same onto the suction table 6 in a horizontal position. In this construction, when the tape feed motor 82 is driven, the printing tape A is fed accurately while being stretched between the feed roller means 81 and the tension roller means 83. Accordingly, a portion of the printing tape A brought to the suction table 6 is sucked in a stretched and positioned state, by the suction table 6 in the horizontal position.

At a location between the tape feed roller means 81 and the suction table 6, there is arranged a tape feed sensor 86 in a manner facing toward the tape feeding path 4. The tape feed sensor 86 and the tape feed motor 82 are connected to the controller 7. Mark C, referred to hereinafter, on the printing tape A are detected by the tape feed sensor 86, and feed operation (or pause operation) of the tape feed motor 82 is controlled based on the sensed marks C. As a result, feeding of the printing tape A, i.e. intermittent feed operation can always be performed accurately for each printable area Aa, described in detail hereinafter, of the printing tape A.

The tape supply device 8 and the tape take-up device 9 are arranged on respective opposite sides (upstream and downstream) of the base 2. The tape supply device 8 rolls out the printing tape A by free rotation, while the tape take-up device 9 takes up the same by forced rotation. The tape supply device 8 is comprised of a supply casing 91 and a reel 92 for rotatably supporting the printing tape (un-used tape) A wound into a roll therearound. In this connection, it is preferred that the printing tape A is guided to the tape feeding mechanism 5 in a sagging state so as to eliminate influences (causing tension and oblique feeding) upon the tape feeding mechanism 5.

The tape take-up device 9 is comprised of a take-up casing 94, a take-up reel 95 arranged in the take-up casing 94, and a take-up motor 96 for driving the take-up reel 95 for rotation for taking up the printing tape (used tape) A. Also in the case of taking up the printing tape A, it is preferred that the printing tape A to be taken up is held in a sagging state so as to eliminate influences (causing tension and oblique feeding) upon the tape feeding mechanism 5.

Next, the main control system constituted by the controller 7 and various printing methods will be described in detail. Referring to FIG. 11, the control system of the printing apparatus is comprised of an input block 101 for inputting image data prepared by an external apparatus, such as a personal computer (PC), according to operations via the operation panel 15, a printing block 102 for performing printing an image at a predetermined position on the printing tape A, the printing block 102 having the printing mechanism (head unit 21, X-Y moving mechanism 23) and the tape feed motor 82, a driving block 103 for driving mechanisms of the apparatus, the driving block 103 having a printer driver and a tape feeding driver, a sensor block 104 having the tape feed sensor 86, and a control block (controller 7) 105 for centralized control of the mechanisms and devices of the printing apparatus 1.

The control block 105 has a CPU 111, a ROM 112, a CG-ROM 113, a RAM 114, and a P-COM 115, all of which are connected to each other via a bus 116. The ROM 112 has a control program area for storing control programs operations of which are executed by the CPU 111, and a control data area for storing control data including character tables and color conversion tables. The CG-ROM 113 stores bit map data of letters, symbols, figures, and so forth, and responsive to code data specifying a letter or the like, delivers bit map data corresponding thereto.

The RAM 114 includes an image data area for storing image data inputted from outside of the apparatus 1, a print image data area for storing image data for printing, conversion buffer areas corresponding to the colors (black (K), cyan (C), magenta (M), yellow (Y), light cyan (LC), and light magenta (LM), and other register groups. The RAM 114 is used as a work area for carrying out the control process.

The P-CON 115 incorporates a logic circuit implemented by gate arrays, a custom LSI and the like, for complementing the functions of the CPU 111 as well as dealing with interface signals for interfacing between the CPU 111 and peripheral circuits. Accordingly, the P-CON 115 is connected to the operation panel 15, for receiving instructions and image data from the input block 101, and inputting these to the internal bus 116 directly or after processing them. Further, the P-CON 115 cooperates with the CPU 111 to output data and control signals input to the internal bus 116 by the CPU 111 and the like, to the driving block 103 directly or after processing them.

The CPU 111 of the control block 105 receives signals from sensors, commands and data, via the P-CON 115, according to the control program read from the ROM 112, processes bit map data from the CG-ROM 113 and various data stored in the RAM 114, and delivers control signals to the driving block 103 via the P-CON 115 to thereby control the operations of the printing mechanism 3 and the tape feed motor 82, to perform printing on the tape A and feeding of the same under predetermined printing conditions. In short, the CPU 111 controls the overall operation of the printing apparatus 1.

For example, when the inputted image data is of color data, data of colors of the color image data are stored in the color conversion buffers within the RAM 114, respectively, and according to the control program read from the ROM 112, the three ink jet heads 22 are controlled. More specifically, based on data read from the black (B) and cyan (C) buffers, the first head 22-1 is controlled, based on data read from the magenta (M) and yellow(Y) buffers, the second head 22-2 is controlled, and based on data read from the light cyan (LC) and light magenta (LM) buffers, the third head 22-3 is controlled.

Now, an image-printing method will be described with reference to FIGS. 1, 3 and 12A to 12D. In the printing apparatus 1, first, the tape feeding mechanism 5 is operated to feed a printing portion, i.e. a printable area Aa, of the printing tape A onto the suction table 6. In this state, the suction table 6 is in operation, so that when feeding of the printing tape A is stopped, the printable area Aa of the printing tape A is sucked onto the suction table 6 and held in an immovable state. Then, the X-Y moving mechanism 23 is operated to move the head unit 21 in the main scanning and sub scanning directions (see FIG. 4A). During this motion of the head unit 21, inks are ejected from the respective ink jet heads 22 of the head unit 21, for image printing.

The image printing is performed for continuously printing a plurality of unit images B on respective label portions of the printing tape A at predetermined space intervals such that a space (non-print area Ab) is formed between each two of the label portions. In the printing, printing operation and tape feeding operation are repeatedly carried out, whereby a desired number of unit images B are printed on the printing tape A. At the same time, the marks C indicative of the position of each unit image B are also printed. Then, when the printing of the unit images B and the marks C on the printable area Aa is completed, the X-Y moving mechanism 23 stops. Subsequently, the tape feeding mechanism 5 is operated to introduce another printable area Aa onto the suction table 6. At this time, the X-Y moving mechanism 23 is operated again to move the head unit 21 in the main scanning and sub scanning directions until the head unit 21 reaches the printing-start position P1. During this motion of the head unit 21, inks are ejected, whereby images (unit images B and marks C) are printed (see FIG. 4B).

As described above, while holding the printing tape A on the suction table 6, printing on one printable area Aa by the main scanning and sub scanning of the head unit, and feeding of the printing tape A for introducing a next printable area Aa to the suction table 6 are repeatedly carried out to print a desired number of label images on the printing tape A. This makes it possible to perform printing with positioning accuracy on a dot level measurement of location, and reduce the ratio of a time for acceleration and deceleration of the head unit 21 to a time over which the actual printing (ejection of ink droplets) is carried out by the head unit 21 to a very small value, thereby making very short ineffective printing time other than the actual printing time. Therefore, it is possible to reduce the printing time and what is more, print a required number of label images without wasting the print medium and ink.

In the above embodiment, while the printing tape A is being fed, the X-Y moving mechanism 23 may move the head unit 21 to the initial print start position P1, and causes printing to be started always therefrom. Further, the printing of the unit image B and printing of marks C may be carried out separately, such that the operation of printing marks C is carried out while feeding the printing tape A. More specifically, within the printable area Aa, a portion for printing marks C (mark printing area AC) may be set outward of a portion for printing images (image printing area AB) (see FIG. 12A), and the head unit 21 is moved to the portion for printing marks C, to print them in this state during the feeding of the printing tape A.

This mark printing method utilizes the feeding of the printing tape A for the main scanning, and the time for feeding the same, which is originally a print interruption time, is assigned to mark printing which does not require relatively high resolution. This makes it possible to reduce printing time as a whole. Further, in this case, by setting the resolution of mark printing to a lower value than that of image printing, the feeding of the printing tape A can be carried out a relatively higher printing speed.

FIGS. 12A to 12B show results of printing on one printable area Aa of the printing tape. In FIG. 12A, a plurality of unit images (label images) B are printed in the direction in which the printing tape A extends with a predetermined space therebetween, and a large number of marks C are also printed at predetermined intervals in parallel with the unit images B. In FIG. 12B, a plurality of marks C are printed such that they are associated with unit images B, respectively. The marks C thus printed are used for detection of the position of each unit image B when the printed portion of the printing tape A is subjected to half-cutting later as well as when the following printable area Aa is accurately fed onto the suction table 6, as described hereinabove. Needless to say, the feeding of it the printing tape A is carried out such that the above-mentioned space (non-print area Ab) between images is formed at a boundary between one printable area Aa and the following one.

On the other hand, in FIGS. 12C and 12D, flushing of the ink jet head 22 is carried out not on the storage unit 24, but on the printing tape A. In FIG. 12C, upon completion of printing of unit images B and marks C one printable area Aa, all the ink jet heads 22 are driven to eject ink droplets toward the trailing end space (non-print area Ab) as regular flushing.

As described hereinbefore, the end user uses the half-cut label portions of the printing tape A, and discards the remainder. Therefore, there is no problem even if flushing is carried out on the non-print area Ab. On the contrary, by carrying regular flushing in this manner, the traveling time of the head unit for flushing is reduced compared with the case in which flushing is carried out to the storage unit 24, thereby making it to increase printing speed as a whole.

Further, in FIG. 12D, the printing method is configured such that regular flushing and printing of marks C are carried out in a combined manner i.e. by common operation. More specifically, marks C are printed on spaces (non-print areas Ab) between adjacent unit images B by carrying out ejection of ink droplets by all the ink jet heads. By carrying out the regular flushing and printing of marks C in a combined manner i.e. by common operation, it is possible to reduce time losses for flushing to zero, whereby the printing speed can be even more increased.

Needless to say, the configuration of the printing method in which regular flushing is carried out to the printing tape (print medium) can be applied to a general ink jet printer which feeds the print medium in the sub scanning direction while causing reciprocating motion of the head unit in the main scanning direction.

It is further understood by those skilled in the art that the foregoing is a preferred embodiment of the invention, and that various changes and modifications may be made without departing from the spirit and scope thereof.

What is claimed is:

1. A printing method for printing on a continuous sheet by moving an ink jet head in a main scanning direction and a sub scanning direction, the printing method comprising the steps of:
performing, on a printable area of the continuous sheet stopped in a sheet feeding path, main scanning in a direction in which the continuous sheet extends and sub scanning in a direction of width of the continuous sheet, to thereby print an image on the printable area; and
feeding the continuous sheet, after completion of the printing, in the direction in which the continuous sheet extends, to print on a following printable area of the continuous sheet,
the above steps being repeatedly carried out to perform continuous printing of the image.

2. A printing method according to claim 1, wherein the printable area has a sufficiently large length in the main scanning direction compared with a length in the sub scanning direction.

3. A printing method according to claim 1, wherein a plurality of unit images are printed in the printable area with non-print areas interposed in the main scanning direction.

4. A printing method according to claim 3, wherein boundaries between the printable areas are included in the non-print areas.

5. A printing method according to claim 1, wherein the continuous sheet is rolled out from a state wound into a roll, and printed part of the continuous sheet is taken up into a roll.

6. A printing apparatus for printing on a continuous sheet, comprising:
a sheet feed mechanism for feeding a continuous sheet along a sheet feeding path in a direction in which the continuous sheet extends;
a head unit carrying ink jet heads thereon for continuously printing an image on the continuous sheet;
an X-Y moving mechanism carrying said head unit thereon and for moving said head unit above the continuous sheet in a main scanning direction which is the direction in which the continuous sheet extends and a sub scanning direction which is a direction of width of the continuous sheet; and
a printing table facing toward the sheet feeding path and opposed to the ink jet heads in printing operation, with the continuous sheet positioned therebetween;
control means for controlling said sheet feed mechanism, the ink jet heads, and said X-Y moving mechanism, and
wherein said control means causes the ink jet heads to perform the main scanning and the sub scanning on a printable area of the continuous sheet which is stopped on said printing table, and feed the continuous sheet, after completion of the printing, in the direction in which the continuous sheet extends, to print on a following printable area of the continuous sheet, such that these operations are repeatedly carried out to perform continuous printing of the image.

7. A printing apparatus according to claim 6, wherein the printable area is set to have a sufficiently large length in the main scanning direction compared with a length in the sub scanning direction.

8. A printing apparatus according to claim 6, wherein said control means causes a plurality of unit images to be printed in the printable area with non-print areas interposed in the main scanning direction.

9. A printing apparatus according to claim 7, wherein said control means causes feeding of the continuous sheet and printing thereon such that boundaries between the printable areas are included in the non-print areas.

10. A printing apparatus according to claim 6, wherein said printing table comprises a suction table performing sucking by suction of air.

11. A printing apparatus according to claim 10, wherein said sheet feeding mechanism feeds the continuous sheet against the suction of air by said printing table.

12. A printing apparatus according to claim 6, further comprising a sheet feed mechanism for rolling out the continuous sheet from a state wound into a roll, and a sheet take-up mechanism for taking up printed part of the continuous sheet into a roll.
